(19) United States
(12) Patent Application Publication
(10) Pub. No.: US 2025/0226118 A1
(43) Pub. Date: Jul. 10, 2025

(54) METHOD, APPARATUS, ELECTRONIC DEVICE, AND STORAGE MEDIUM FOR MONITORING NITROGEN DEMAND OF FRUIT TREE

(71) Applicant: Tarim University, Ala’er City (CN)

(72) Inventors: Tiecheng BAI, Ala’er City (CN); Nannan ZHANG, Ala’er City (CN); Yong HE, Ala’er City (CN); Jianxi HUANG, Ala’er City (CN)

(21) Appl. No.: 18/946,376

(22) Filed: Nov. 13, 2024

(30) Foreign Application Priority Data
Jan. 4, 2024 (CN) 202410013678.7

(51) Int. Cl. G16Z 99/00

(52) U.S. Cl. CPC G16Z 99/00

(57) ABSTRACT

Provided are a method, apparatus, electronic device, and storage medium for monitoring a nitrogen demand of a fruit tree. The method includes acquiring plant input parameters of a fruit tree to be monitored, where the plant input parameters at least include a phenological development accumulated temperature parameter, a green leaf parameter, a photosynthesis parameter, a respiration parameter, a dry matter accumulation parameter, a partitioning parameter, and a nitrogen transport parameter. A target monitoring model is constructed, where the target monitoring model is a WOrld FOod Studies (WOFOST) model integrating nitrogen monitoring. The plant input parameters of the fruit tree to be monitored are input into the target monitoring model to obtain a nitrogen demand of the fruit tree to be monitored that is output by the target monitoring model.

### CROSS REFERENCE TO RELATED APPLICATION

This patent application claims the benefit and priority of Chinese Patent Application No. 202410013678.7, filed with the China National Intellectual Property Administration on Jan. 4, 2024, the disclosure of which is incorporated by reference herein in its entirety as part of the present application.

### TECHNICAL FIELD

The present disclosure relates to the technical field of nitrogen demand, and in particular to a method, apparatus, electronic device, and storage medium for monitoring a nitrogen demand of a fruit tree.

### BACKGROUND

Nitrogen fertilizers are a class of fertilizers with the largest production and consumption worldwide. A nitrogen fertilizer is a basic nutrient component for the growth of a fruit tree. The application of a nitrogen fertilizer at an appropriate amount plays an important role in improving a yield and a quality of a fruit. However, the rough fertilization not only affects a yield and a quality of a fruit, but also leads to waste of resources, environmental pollution, and ecological degradation. The real-time and accurate analysis of a nitrogen demand of a fruit tree is a prerequisite for the accurate application of a nitrogen fertilizer to the fruit tree.

According to relevant technologies, a nitrogen demand of a fruit tree is currently often analyzed manually, which results in a too-high analysis cost and cannot guarantee the real-time analysis and monitoring of a small nitrogen demand of a fruit tree.

Therefore, the development of a method for monitoring a nitrogen demand of a fruit tree in real time that can reduce a working cost has become a research focus.

### SUMMARY

The present disclosure provides a method, apparatus, electronic device, and storage medium for monitoring a nitrogen demand of a fruit tree. The present disclosure can allow the low-cost and real-time monitoring of a nitrogen demand of a fruit tree, so as to enable the accurate application of a nitrogen fertilizer to the fruit tree.

The present disclosure provides a method for monitoring a nitrogen demand of a fruit tree, including acquiring plant input parameters of a fruit tree to be monitored, where the plant input parameters at least include a phenological development accumulated temperature parameter, a green leaf parameter, a photosynthesis parameter, a respiration parameter, a dry matter accumulation parameter, a partitioning parameter, and a nitrogen transport parameter.A target monitoring model is constructed, where the target monitoring model is a World Food Studies (WOFOST) model integrating nitrogen monitoring. The plant input parameters of the fruit tree to be monitored are input into the target monitoring model to obtain ta nitrogen demand of the fruit tree to be monitored that is output by the target monitoring model.

According to the method for monitoring a nitrogen demand of a fruit tree provided by the present disclosure, the target monitoring model is constructed by acquiring an initial WOFOST model; based on a first nitrogen content produced from mineralization and/or biological nitrogen fixation, a nitrogen use efficiency of the fruit tree, and a nitrogen absorption rate of the fruit tree, constructing a soil nitrogen balance function; based on an actual nitrogen content of the fruit tree, a critical nitrogen content of the fruit tree, and a residual nitrogen content of the fruit tree, constructing a nitrogen balance function between soil and the fruit tree; acquiring a leaf growth rate function of the fruit tree under nitrogen stress and a biomass change function of the fruit tree under nitrogen stress; and based on the soil nitrogen balance function, the nitrogen balance function between the soil and the fruit tree, the leaf growth rate function, and the biomass change function, improving the initial WOFOST model to obtain the target monitoring model.

According to the method for monitoring a nitrogen demand of a fruit tree provided by the present disclosure, the leaf growth rate function is constructed by acquiring a leaf nitrogen nutrient index of the fruit tree; and based on the leaf nitrogen nutrient index, constructing the leaf growth rate function.

According to the method for monitoring a nitrogen demand of a fruit tree provided by the present disclosure, the biomass change function of the fruit tree under nitrogen stress is constructed by acquiring a radiation quantity of the fruit tree, a canopy nitrogen distribution coefficient of the fruit tree, and a light energy use efficiency of the fruit tree; and based on the radiation quantity of the fruit tree, the canopy nitrogen distribution coefficient of the fruit tree, and the light energy use efficiency of the fruit tree, constructing the biomass change function of the fruit tree under nitrogen stress.

According to the method for monitoring a nitrogen demand of a fruit tree provided by the present disclosure, after the initial WOFOST model is improved based on the soil nitrogen balance function, the nitrogen balance function between the soil and the fruit tree, the leaf growth rate function, and the biomass change function to obtain the target monitoring model, the method further includes: acquiring a development rate, a light duration correction coefficient, an average daily temperature, and a minimum development temperature of the fruit tree; based on the development rate, the light duration correction coefficient, the average daily temperature, and the minimum development temperature of the fruit tree, constructing a development value function of the fruit tree; and optimizing the target monitoring model based on the development value function to obtain an optimized target monitoring model, and taking the optimized target monitoring model as a final target monitoring model.

According to the method for monitoring a nitrogen demand of a fruit tree provided by the present disclosure, after the initial WOFOST model is improved based on the soil nitrogen balance function, the nitrogen balance function between the soil and the fruit tree, the leaf growth rate function, and the biomass change function to obtain the target monitoring model, the method further includes: based on a growth rate of leaf net dry matters of the fruit tree, constructing a growth rate function of a leaf area index; based on a dry matter weight gain per unit time of the fruit tree, constructing a dry matter weight generation function; and optimizing the target monitoring model based on the growth rate function of the leaf area index and the dry matter weight generation function to obtain an optimized target monitoring model, and taking the optimized target monitoring model as a final target monitoring model.

According to the method for monitoring a nitrogen demand of a fruit tree provided by the present disclosure, after the initial WOFOST model is improved based on the soil nitrogen balance function, the nitrogen balance function between the soil and the fruit tree, the leaf growth rate function, and the biomass change function to obtain the target monitoring model, the method further includes: acquiring sample plant input parameters of a correction fruit tree sample; and correcting the target monitoring model based on the sample plant input parameters to obtain a corrected target monitoring model, and taking the corrected target monitoring model as a final target monitoring model.

The present disclosure also provides an apparatus for monitoring a nitrogen demand of a fruit tree, including: an acquisition module configured to acquire plant input parameters of the fruit tree to be monitored, where the plant input parameters at least include a phenological development accumulated temperature parameter, a green leaf parameter, a photosynthesis parameter, a respiration parameter, a dry matter accumulation parameter, a partitioning parameter, and a nitrogen transport parameter; a construction module configured to construct a target monitoring model, where the target monitoring model is a WOFOST model integrating nitrogen monitoring; and a processing module configured to input the plant input parameters of the fruit tree to be monitored into the target monitoring model to obtain the nitrogen demand of the fruit tree to be monitored that is output by the target monitoring model.

The present disclosure also provides an electronic device, including a memory, a processor, and a computer program that is stored in the memory and able to run on the processor, where when executing the computer program, the processor implements the method for monitoring a nitrogen demand of a fruit tree described above.

The present disclosure also provides a non-transitory computer-readable storage medium in which a computer program is stored, where when executed by a processor, the computer program implements the method for monitoring a nitrogen demand of a fruit tree described above.

The present disclosure also provides a computer program product including a computer program, where when executed by a processor, the computer program implements the method for monitoring a nitrogen demand of a fruit tree described above.

The present disclosure provides a method, apparatus, electronic device, and storage medium for monitoring a nitrogen demand of a fruit tree. The method includes: plant input parameters of the fruit tree to be monitored are acquired, where the plant input parameters at least include a phenological development accumulated temperature parameter, a green leaf parameter, a photosynthesis parameter, a respiration parameter, a dry matter accumulation parameter, a partitioning parameter, and a nitrogen transport parameter; a target monitoring model is constructed, where the target monitoring model is a WOFOST model integrating nitrogen monitoring; and the plant input parameters of the fruit tree to be monitored are input into the target monitoring model to automatically obtain the nitrogen demand of the fruit tree to be monitored that is output by the target monitoring model. The present disclosure can allow the low-cost and real-time monitoring of a nitrogen demand of a fruit tree, so as to enable the accurate application of a nitrogen fertilizer to the fruit tree.

### BRIEF DESCRIPTION OF THE DRAWINGS

To describe the technical solutions in the present disclosure or in the prior art clearly, the accompanying drawings required for describing the embodiments or the prior art are briefly described below. Apparently, the accompanying drawings in the following description show some embodiments of the present disclosure, and a person of ordinary skill in the art may still derive other accompanying drawings from these accompanying drawings without creative efforts.

FIG. 1 is a schematic flow chart of the method for monitoring a nitrogen demand of a fruit tree provided in the present disclosure;

FIG. 2 is a first schematic flow chart of constructing a target monitoring model provided in the present disclosure;

FIG. 3 is a second schematic flow chart of constructing a target monitoring model provided in the present disclosure;

FIG. 4 is a third schematic flow chart of constructing a target monitoring model provided in the present disclosure;

FIG. 5 is a schematic diagram of a structure of the apparatus for monitoring a nitrogen demand of a fruit tree provided in the present disclosure; and

FIG. 6 is a schematic diagram of a structure of the electronic device provided in the present disclosure.

### DETAILED DESCRIPTION OF THE EMBODIMENTS

To make the objectives, technical solutions, and advantages of the present disclosure clear, the technical solutions in the present disclosure are clearly and completely described below with reference to the accompanying drawings in the present disclosure. Apparently, the described embodiments are some rather than all of the embodiments of the present disclosure. All other embodiments obtained by those of ordinary skill in the art based on the embodiments of the present disclosure without creative efforts should fall within the protection scope of the present disclosure.

The present disclosure provides a method for monitoring a nitrogen demand of a fruit tree. In the method, the growth of a fruit tree is simulated through phenological development and light energy interception processes of an improved WOFOST model, and nitrogen transport and effect evaluation processes are integrated in the original WOFOST model, so as to allow the real-time and quantitative analysis of a soil nitrogen content, a nitrogen use efficiency, a nitrogen stress time, and a nitrogen demand.

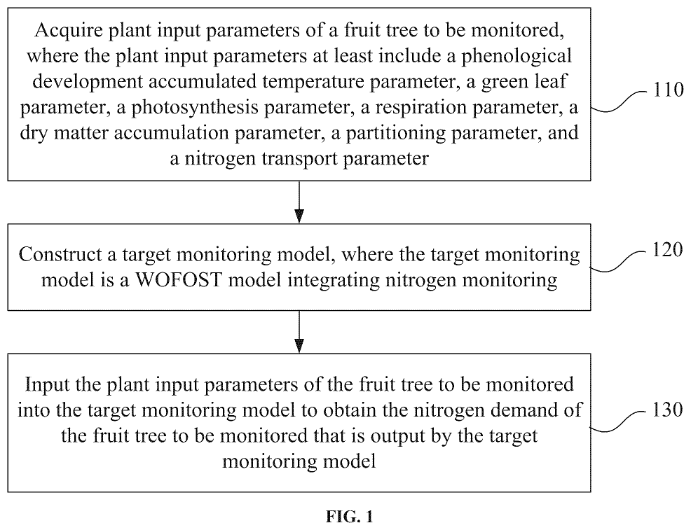

FIG. 1 is a schematic flow chart of the method for monitoring a nitrogen demand of a fruit tree provided in the present disclosure.

The method for monitoring a nitrogen demand of a fruit tree provided in the present disclosure is illustrated below with reference to FIG. 1.

In an exemplary embodiment of the present disclosure, as shown in FIG. 1, the method for monitoring a nitrogen demand of a fruit tree can include steps 110 to 130, which are introduced separately below:

Step 110: Plant input parameters of the fruit tree to be monitored are acquired. The plant input parameters at least include a phenological development accumulated temperature parameter, a green leaf parameter, a photosynthesis parameter, a respiration parameter, a dry matter accumulation parameter, a partitioning parameter, and a nitrogen transport parameter.

Step 120: A target monitoring model is constructed. The target monitoring model is a WOFOST model integrating nitrogen monitoring.

Step 130: The plant input parameters of the fruit tree to be monitored are input into the target monitoring model to obtain the nitrogen demand of the fruit tree to be monitored that is output by the target monitoring model.

In an embodiment, plant input parameters about the fruit tree to be monitored can be acquired. The fruit tree to be monitored can be understood as a fruit tree whose nitrogen demand needs to be monitored. The plant input parameters can be plant input parameters at any time point, and the nitrogen demand of the fruit tree to be monitored that is output by the target monitoring model correspondingly will also be a nitrogen demand at any time point. In other words, in the method for monitoring a nitrogen demand of a fruit tree provided in the present disclosure, the nitrogen demand of the fruit tree to be monitored can be obtained in real time based on the plant input parameters, which enables the accurate application of a nitrogen fertilizer to the fruit tree.

In another embodiment, the target monitoring model can be constructed in advance. The target monitoring model may include a function of integrating nitrogen monitoring, such that the plant input parameters of the fruit tree to be monitored can be input into the target monitoring model to obtain the nitrogen demand of the fruit tree to be monitored that is output by the target monitoring model.

In another embodiment, the plant input parameters may also include data such as a maximum temperature, a minimum temperature, a radiation, a rainfall, and a water vapor pressure observed by a weather station and parameters such as a soil water-retention capacity, a bulk density, a saturated soil water content, a soil response curve parameter, and an infiltration coefficient.

In an application process, a model (corresponding to the target monitoring model) can be driven to run to simulate a growth process, a final yield, and a nitrogen use efficiency of a fruit tree, an impact of nitrogen stress on the growth of the fruit tree, and a soil nitrogen content, a fruit tree absorption capacity, a nitrogen stress coefficient, and a nitrogen demand on each day.

The method for monitoring a nitrogen demand of a fruit tree provided in the present disclosure includes: Plant input parameters of the fruit tree to be monitored are acquired. The plant input parameters at least include a phenological development accumulated temperature parameter, a green leaf parameter, a photosynthesis parameter, a respiration parameter, a dry matter accumulation parameter, a partitioning parameter, and a nitrogen transport parameter. A target monitoring model is constructed. The target monitoring model is a WOFOST model integrating nitrogen monitoring. The plant input parameters of the fruit tree to be monitored are input into the target monitoring model to automatically obtain the nitrogen demand of the fruit tree to be monitored that is output by the target monitoring model. The present disclosure can allow the low-cost and real-time monitoring of a nitrogen demand of a fruit tree, so as to enable the accurate application of a nitrogen fertilizer to the fruit tree.

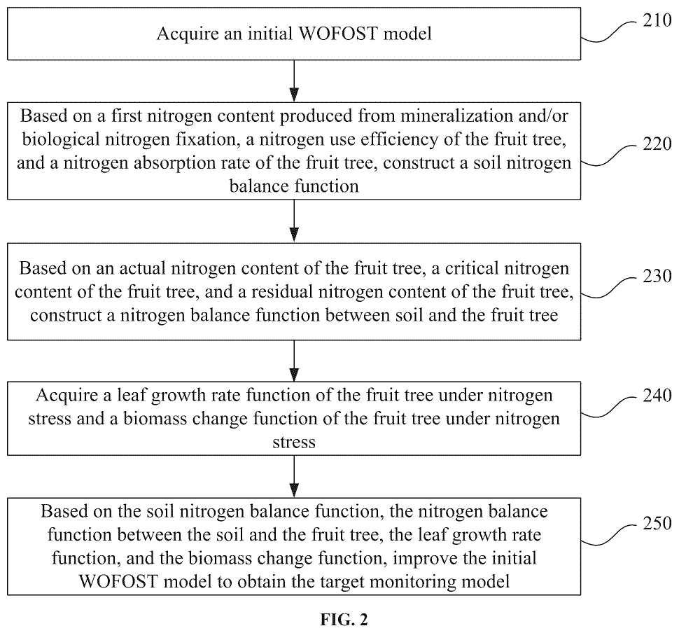

FIG. 2 is a first schematic flow chart of constructing the target monitoring model provided in the present disclosure.

A first process of constructing the target monitoring model is illustrated below with reference to FIG. 2.

In an exemplary embodiment of the present disclosure, as shown in FIG. 2, the target monitoring model can constructed by steps 210 to 250, which are introduced separately below:

Step 210: An initial WOFOST model is acquired.

Step 220: Based on a first nitrogen content produced from mineralization and/or biological nitrogen fixation, a nitrogen use efficiency of the fruit tree, and a nitrogen absorption rate of the fruit tree, a soil nitrogen balance function is constructed.

Step 230: Based on an actual nitrogen content of the fruit tree, a critical nitrogen content of the fruit tree, and a residual nitrogen content of the fruit tree, a nitrogen balance function between soil and the fruit tree is constructed.

Step 240: A leaf growth rate function of the fruit tree under nitrogen stress and a biomass change function of the fruit tree under nitrogen stress are acquired.

Step 250: Based on the soil nitrogen balance function, the nitrogen balance function between the soil and the fruit tree, the leaf growth rate function, and the biomass change function, the initial WOFOST model is improved to obtain the target monitoring model.

In an embodiment, an initial WOFOST model can be acquired in advance. The initial WOFOST model is the existing WOFOST model. The initial WOFOST model does not include functions such as nitrogen transport and effect evaluation. Thus, in this embodiment, nitrogen kinetic theories and methods can be coupled in the initial WOFOST model, including a soil nitrogen balance, a soil-plant nitrogen balance, and an impact of nitrogen stress on the growth of a plant.

In another embodiment, based on a first nitrogen content produced from mineralization and/or biological nitrogen fixation, a nitrogen use efficiency of the fruit tree, and a nitrogen absorption rate of the fruit tree, a soil nitrogen balance function can be constructed. The soil nitrogen balance function mainly involves a quantity of a nitrogen fertilizer applied, a content of nitrogen converted into mineralized nitrogen, a quantity of nitrogen absorbed by a plant, and a nitrogen loss. In an example, the soil nitrogen balance function can be allowed by the following equation (1):

$${( \frac{d N}{dt} )}_{soil} = {N}_{min} + ( Q {N}_{fer} NRF ) - ( \frac{d N U}{dt} ) where {( \frac{d N}{dt} )}_{soil} \qquad ( 1 )$$

represents a net change rate of nitrogen in a soil; Nₘᵢₙ represents nitrogen produced from mineralization and biological nitrogen fixation, which corresponds to the first nitrogen content produced from mineralization and/or biological nitrogen fixation; QN_{fer} represents a utilization rate of a nitrogen fertilizer, which corresponds to the nitrogen use efficiency of the fruit tree; NRF represents a quantity of a nitrogen fertilizer that can be reused; and dNU/dt represents an absorption rate of a nitrogen fertilizer, which corresponds to the nitrogen absorption rate of the fruit tree.

In another embodiment, based on an actual nitrogen content of the fruit tree, a critical nitrogen content of the fruit tree, and a residual nitrogen content of the fruit tree, a nitrogen balance function between soil and the fruit tree can be constructed. In an example, three central nitrogen content values for a nitrogen dynamic cycle include an actual nitrogen content NC_{act}, which can correspond to the actual nitrogen content of the fruit tree; a critical nitrogen content NC_{crt}, which can correspond to the critical nitrogen content of the fruit tree; and a residual nitrogen content NCᵣₑₛ. The actual nitrogen content refers to a quantity of nitrogen accumulated during a growth process of a plant. The critical nitrogen content is calculated by the following equation (2):

$${NC}_{crt} = a ( 1 + {be}^{- 0.26 W} ) \qquad ( 2 )$$

where a and b each represent a crop coefficient (which varies from crop to crop) and are obtained by fitting critical nitrogen content and dry weight data from field measurements, and W represents a cumulative dry weight of a plant.

A nitrogen demand of a plant is a sum of nitrogen demand by organs of the plant. A potential nitrogen demand and an actual nitrogen content of each organ are different. A potential nitrogen demand refers to a maximum one among nitrogen contents of each organ at different growth stages. The following equation (3) is provided to characterize a relationship between a potential nitrogen demand and a maximum nitrogen content:

$${TN}_{dem} = {\sum }_{i = 1}^{n} {N}_{max , i} {W}_{i} - {AN}_{i} \qquad ( 3 )$$

where TN_{dem} represents a potential nitrogen demand, N_{max,i} represents a maximum nitrogen content of an organ i, Wᵢ represents a dry weight of an organ i, and ANᵢ represents an actual nitrogen content of an organ i.

A plant first absorbs mineralized nitrogen from parent organic matters, and then absorbs nitrogen from a fertilizer. Total nitrogen absorbed by a crop is partitioned among different organs in proportions according to needs, and a corresponding nitrogen demand relationship is shown in the following equation (4):

$${( \frac{dNU}{dt} )}_{i} = ( \frac{{N}_{dem , i}}{{TN}_{dem}} ) ( \frac{dNU}{dt} ) \qquad ( 4 )$$

$$where {( \frac{dNU}{dt} )}_{i}$$

represents a rate of nitrogen absorption of an organ i and N_{dem,i} represents a nitrogen demand of an organ i.

A nitrogen accumulation rate of a nitrogen-storing organ of a crop depends on a nitrogen demand calculated from a maximum nitrogen content and an actual nitrogen content and a total quantity of transportable nitrogen in other organs of the crop. A total quantity of transportable nitrogen in a crop is obtained by subtracting a content of the remaining non-transferable nitrogen from a content of total nitrogen in each organ. A change rate

$${( \frac{dN}{dt} )}_{i}$$

of nitrogen in each organ can be calculated according to the following equation (5):

$${( \frac{dN}{dt} )}_{i} = {( \frac{dNU}{dt} )}_{i} - {( \frac{dNT}{dt} )}_{i} - {( \frac{dND}{dt} )}_{i} \qquad ( 5 )$$

$$where {( \frac{dNU}{dt} )}_{i} , {( \frac{dNT}{dt} )}_{i} , and {( \frac{dND}{dt} )}_{i}$$

represent a contribution of nitrogen absorption of an organ i, a transport of nitrogen of the organ, and a loss of nitrogen caused by organ death, respectively.

It should be noted that the combination of the equations (2) to (5) can be considered as the nitrogen balance function between the soil and the fruit tree.

In another embodiment, a leaf growth rate function of the fruit tree under nitrogen stress and a biomass change function of the fruit tree under nitrogen stress can be acquired. Further, based on the soil nitrogen balance function, the nitrogen balance function between the soil and the fruit tree, the leaf growth rate function, and the biomass change function, the initial WOFOST model is improved to obtain the target monitoring model. In another example, the combination of the initial WOFOST model, the soil nitrogen balance function, the nitrogen balance function between the soil and the fruit tree, the leaf growth rate function, and the biomass change function can be adopted as the target monitoring model.

In another exemplary embodiment of the present disclosure, the description is conducted further with the embodiment described above as an example. The leaf growth rate function can be constructed by the following process:

A leaf nitrogen nutrient index of the fruit tree is acquired.

Based on the leaf nitrogen nutrient index, the leaf growth rate function is constructed.

In an embodiment, the nitrogen stress leads to the reduction of a biomass partitioned to leaves, which ultimately limits the growth of leaves and accelerates the senescence of leaves. A partition coefficient of leaves can be calibrated by the following equation (6):

$${pc}_{lv , ns} = {pc}_{lv} {e}^{- ( 1 - NNI )} \qquad ( 6 )$$

where pcᵢᵥ and pc_{iv,ns} represent biomasses partitioned to leaves under appropriate nitrogen and nitrogen stress, respectively, and NNI represents a nitrogen nutrient index.

The nitrogen stress reduces the growth of leaves that is associated with NNI. Corresponding relationships are shown in the following equations (7) and (8):

$${( \frac{dGLAI}{dt} )}_{exp} = {LAI}_{t} {RLT}_{e} NNI DVS < 0.2 , LAI < 0.75 \qquad ( 7 )$$

$${( \frac{dGLAI}{dt} )}_{sl} = {( \frac{dW}{dt} )}_{lv}^{{S}_{la} NNI} DVS \geq 0.2 or LAI \geq 0.75 \qquad ( 8 )$$

$$where {( \frac{dGLAI}{dt} )}_{exp} and {( \frac{dGLAI}{dt} )}_{sl}$$

represent leaf growth rates at sink-limited and source-limited growth stages, respectively, and it can be understood that the above two rates can constitute the leaf growth rate function; LAIₜ represents a leaf area index at a time t; RL represents a maximum relative growth rate; and Sₗₐ represents an SLA parameter of the WOFOST model. It should be noted that the equations (6) to (8) above constitute the leaf growth rate function.

In another exemplary embodiment of the present disclosure, the description is conducted further with the embodiment described above as an example. The biomass change function of the fruit tree under nitrogen stress can be constructed by the following process:

A radiation quantity of the fruit tree, a canopy nitrogen distribution coefficient of the fruit tree, and a light energy use efficiency of the fruit tree are acquired.

Based on the radiation quantity of the fruit tree, the canopy nitrogen distribution coefficient of the fruit tree, and the light energy use efficiency of the fruit tree, the biomass change function of the fruit tree under nitrogen stress is constructed.

In an embodiment, an impact of nitrogen stress on a biomass can be expressed by the following equation (9):

$$\frac{dW}{dt} = 0.5 {Q}_{0} ( 1 - {e}^{- kLAI} ) {LUEe}^{- ε ( 1 - NNI )} \qquad ( 9 )$$

where Q₀ represents a total radiation per day (MJ m⁻² d⁻¹), which can correspond to the radiation quantity of the fruit tree; k represents an attenuation coefficient (m² m⁻²); ε represents a canopy nitrogen distribution coefficient, which can correspond to the canopy nitrogen distribution coefficient of the fruit tree; LUE represents a light energy use efficiency, which can correspond to the light energy use efficiency of the fruit tree; and dW/dt represents a biomass change of the fruit tree under nitrogen stress.

In an another embodiment, a leaf area loss (dDLAI/dt) caused by nitrogen stress can be calculated by the following equation (10):

$$( \frac{dDLAI}{dt} ) = {W}_{lv , g} {RDR}_{ns} ( 1 - NNI ) {S}_{la} \qquad ( 10 )$$

where W_{iv,g} represents a weight of green leaves and RDRₙₛ represents a maximum mortality rate of green leaves caused by nitrogen stress.

Further, an actual biomass and a leaf area index can be calculated.

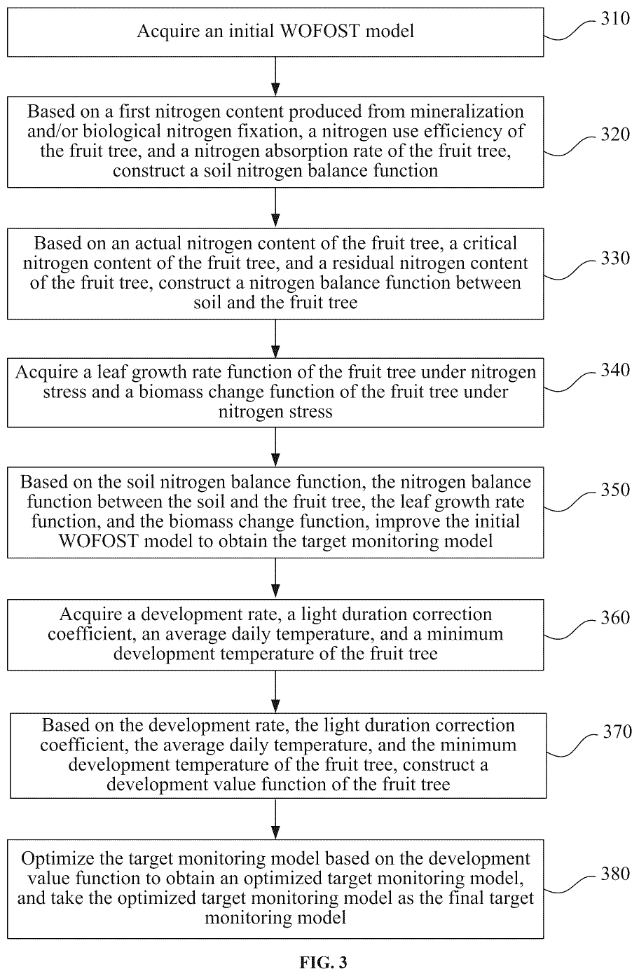

FIG. 3 is a second schematic flow chart of constructing a target monitoring model provided in the present disclosure.

A second process of constructing the target monitoring model is illustrated below with reference to FIG. 3.

In an exemplary embodiment of the present disclosure, as shown in FIG. 3, the second process of constructing the target monitoring model can include steps 310 to 380. The steps 310 to 350 are the same as or similar to the steps 210 to 250 described above. The specific implementation and beneficial effects are described with reference to the previous description, and are not specifically limited in this embodiment. The steps 360 to 380 are introduced separately below:

In the step 360, a development rate, a light duration correction coefficient, an average daily temperature, and a minimum development temperature of the fruit tree are acquired.

In the step 370, based on the development rate, the light duration correction coefficient, the average daily temperature, and the minimum development temperature of the fruit tree, a development value function of the fruit tree is constructed.

In the step 380, the target monitoring model is optimized based on the development value function to obtain an optimized target monitoring model, and the optimized target monitoring model is taken as a final target monitoring model.

In the initial WOFOST model, the crop development is defined according to a phenological development stage (DVS) as a function of heat summation. DVS is an equation related to a daily effective accumulated temperature, which is a difference between an average daily temperature and a minimum base temperature. According to the BBCH scale widely used internationally, the crop development is divided into 10 main development stages (fruit trees usually lack the second and fourth stages). Each main development stage is divided into 10 secondary growth stages. Based on the criteria of the BBCH scale for distinguishing different development stages, a stage from budding to maturity (00-99) of the fruit tree is standardized as the phenological development stage of WOFOST (0-2).

In the present disclosure, in order to improve the accuracy of the phenological development process, the development value function of the fruit tree is constructed according to the following equations (11) and (12):

$${D}_{r , t} = \frac{D - {D}_{c}}{{D}_{O} - {D}_{C}} \times \frac{{T}_{e}}{{T}_{sum , s}} and \qquad ( 11 )$$

$${D}_{s , t} = {D}_{s , t - 1} + {D}_{r , t} Δ t \qquad ( 12 )$$

where D_{s,t} and D_{s,t-1} represent development values on day t (which can be the day) and day t−1 (which can be the day before); D_{r,t} represents a development rate, which can correspond to the development rate of the fruit tree;

$$\frac{D - {D}_{c}}{{D}_{O} - {D}_{C}}$$

represents a correction coefficient of a day length, which can correspond to the light duration correction coefficient; Tₑ represents a value produced by subtracting a minimum development temperature from an average temperature of the day (corresponding to the daily average temperature); and T_{sum,s} represents an effective accumulated temperature of a preset development stage.

Further, the target monitoring model can be optimized based on the development value function to obtain an optimized target monitoring model, and the optimized target monitoring model is taken as a final target monitoring model. In an application process, the final target monitoring model is taken as a model configured to process the plant input parameters of the fruit tree to be monitored. Through this model, the nitrogen demand of the fruit tree to be monitored can be monitored accurately.

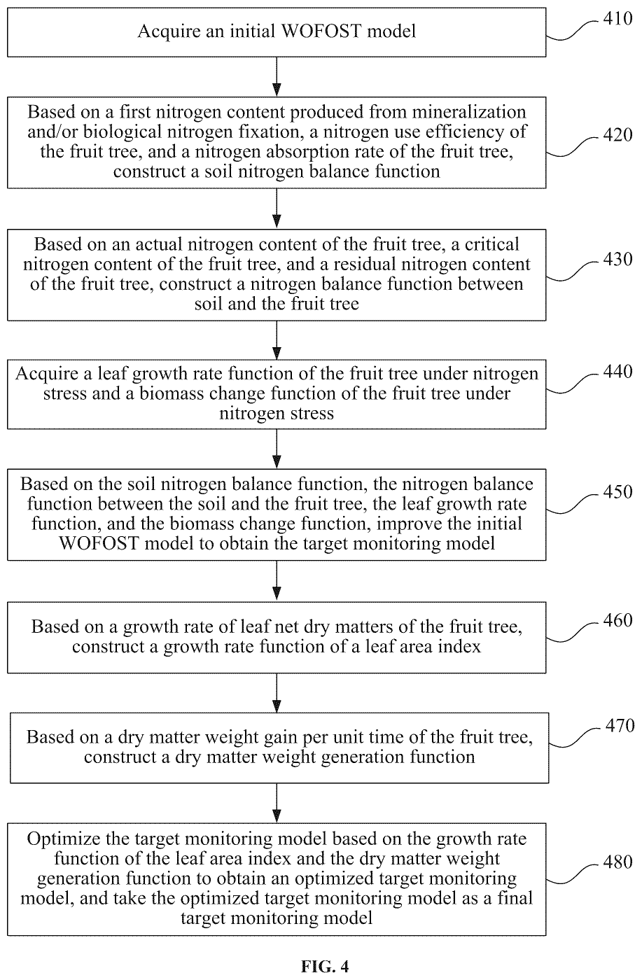

FIG. 4 is a third schematic flow chart of constructing a target monitoring model provided in the present disclosure.

A third process of constructing the target monitoring model is illustrated below with reference to FIG. 4.

In an exemplary embodiment of the present disclosure, as shown in FIG. 4, the third process of constructing the target monitoring model can include steps 410 to 480. The steps 410 to 450 are the same as or similar to the steps 210 to 250 described above. The specific implementation and beneficial effects are described with reference to the previous description, and are not specifically limited in this embodiment. The steps 460 to 480 are introduced separately below:

The step 460: Based on a growth rate of leaf net dry matters of the fruit tree, a growth rate function of a leaf area index is constructed.

The step 470: Based on a dry matter weight gain per unit time of the fruit tree, a dry matter weight generation function is constructed.

The step 480: The target monitoring model is optimized based on the growth rate function of the leaf area index and the dry matter weight generation function to obtain an optimized target monitoring model, and the optimized target monitoring model is taken as a final target monitoring model.

The initial WOFOST model does not consider a pruning process of a fruit tree. In the present disclosure, a pruning process is considered on the basis of photosynthesis simulation of the initial WOFOST model, and the impacts of different pruning amounts on a leaf area index and a biomass are quantified to improve a photosynthesis simulation method.

The WOFOST model assumes that an early plant growth curve is exponential, and an exponential growth rate of a leaf area index is assumed to be continuous until the growth of limited sources of the leaf area index is equal to the exponential growth rate. An exponential growth rate of a leaf area for each time step of an exponential growth stage can be calculated according to the following equation (13), and a cumulative leaf area index for a time step t can be calculated according to the following equation (14):

$${L}_{Exp , t} = {LAI}_{t} {RLT}_{e} \qquad ( 13 )$$

$${LAI}_{t} = {LAI}_{t - 1} + {L}_{Exp , t} Δ t \qquad ( 14 )$$

where L_{Exp,t} represents a growth rate of a leaf area index at a time t during an exponential growth stage (ha ha⁻¹ d⁻¹); LAIₜ represents a leaf area index at a time t (ha ha⁻¹); RL represents a maximum growth rate of a leaf area index per day; Tₑ represents a value produced by subtracting a minimum development temperature from an average temperature of the day; and Δt represents a time step (1 d).

During a phenological process of plant growth, the assimilate supply (namely, the increase in limited sources) limits the expansion of a leaf area. In the WOFOST model, the exponential growth rate of the leaf area index will continuously increase to be equal to a source-limited growth rate. For a time step t at a source-limited growth stage, a growth rate of a leaf area index can be calculated according to the following equation (15), and at the source-limited growth stage, a cumulative leaf area index for the time step t can be calculated according to the following equation (16):

$${L}_{Sc , t} = Δ {Wn}_{lv} {S}_{la} \qquad ( 15 )$$

$${LAI}_{t} = {LAI}_{t - 1} + {L}_{Sc , t} Δ t \qquad ( 16 )$$

where L_{Sc,t} represents a growth rate of a leaf area index at a time t under source-limited conditions (ha ha⁻¹ d⁻¹); ΔWnᵢᵥ represents a growth rate of leaf net dry matters at a time t (kg ha⁻¹ d⁻¹); and Sₗₐ represents a special leaf area at a time t, which is calculated based on leaf weights and leaf areas measured at different development times. It should be noted that the equations (13) to (16) can together constitute the growth rate function of the leaf area index.

The pruning in summer will reduce weights of the new leaves and the branches and trunk. In another embodiment, a dry matter mass of each organ can be calculated according to the following equation (17):

$${W}_{t , i} = ( 1 - {p}_{i} ) {W}_{t - 1 , i} + Δ {Wn}_{i} Δ t \qquad ( 17 )$$

where pᵢ represents a pruning amount (%); W_{t,i} represents a dry matter weight of an organ i (stems and leaves) at a time t (kg ha⁻¹), which can correspond to the dry matter weight generated; and ΔWnᵢ represents a dry matter weight gain of an organ i (stems and leaves) per unit time, which can correspond to the dry matter weight gain per unit time of the fruit tree.

Because the leaves pruned off in summer are new leaves, in order to calculate a new LAI, a pruning amount needs to be subtracted from the original calculation equation, which is calculated according to the following equation (18):

$$LASUM = ( 1 - p ) \cdot ( LV + {S}_{la} ) \qquad ( 18 )$$

ASUM represents a cumulative increase in a leaf area index per unit weight; LV represents a leaf biomass per leaf unit (ha kg⁻¹); Sₗₐ represents a special leaf area (ha kg⁻¹); and p represents a pruning amount of leaves.

Further, the target monitoring model can be optimized based on the development value function to obtain an optimized target monitoring model, and the optimized target monitoring model is taken as a final target monitoring model. In an application process, the final target monitoring model is taken as a model configured to process the plant input parameters of the fruit tree to be monitored. Through this model, the nitrogen demand of the fruit tree to be monitored can be monitored accurately.

As a variation, an optimized target monitoring model produced after the steps 360, 370, 460, and 470 can be taken as a final target monitoring model.

In another exemplary embodiment of the present disclosure, the illustration is conducted further with reference to the embodiment shown in FIG. 2. After the initial WOFOST model is improved based on the soil nitrogen balance function, the nitrogen balance function between soil and the fruit tree, the leaf growth rate function, and the biomass change function to obtain the target monitoring model (which can correspond to the step 250), the method for monitoring a nitrogen demand of a fruit tree can further include the following steps:

Sample plant input parameters of a correction fruit tree sample are acquired.

The target monitoring model is corrected based on the sample plant input parameters to obtain a corrected target monitoring model, and the corrected target monitoring model is taken as a final target monitoring model.

In an application process, the plant input parameters of the improved WOFOST model can be corrected with a phenological development time, leaf and fruit growths, and a soil nitrogen content measured in the field during a growing season of the fruit tree, that is, the target monitoring model can be corrected according to the sample plant input parameters. It should be noted that the sample plant input parameters are corresponding to the plant input parameters of the fruit tree to be monitored above, but the former are plant input parameters about the correction fruit tree sample and the latter are plant input parameters about the fruit tree to be monitored.

Correction parameters can include a phenological development accumulated temperature, an initial parameter, a green leaf parameter, a photosynthesis parameter, a respiration parameter, dry matter accumulation and partitioning parameters, and a nitrogen transport parameter. The observed germination, flowering, and fruit ripening dates are used to verify a phenological simulation accuracy of the improved model, leaf and fruit growths are used to verify a simulation accuracy of a growth process of the fruit tree, and a soil nitrogen content is used to verify a simulation accuracy of a nitrogen transport process.

It should be noted that the protection scope of the present disclosure can encompass any combination of the above embodiments in addition to the above embodiments, and is not specifically limited in this embodiment.

According to the above descriptions, the method for monitoring a nitrogen demand of a fruit tree provided in the present disclosure includes: Plant input parameters of the fruit tree to be monitored are acquired. The plant input parameters at least include a phenological development accumulated temperature parameter, a green leaf parameter, a photosynthesis parameter, a respiration parameter, a dry matter accumulation parameter, a partitioning parameter, and a nitrogen transport parameter. A target monitoring model is constructed. The target monitoring model is a WOFOST model integrating nitrogen monitoring. The plant input parameters of the fruit tree to be monitored are input into the target monitoring model to automatically obtain the nitrogen demand of the fruit tree to be monitored that is output by the target monitoring model. The present disclosure can allow the low-cost and real-time monitoring of a nitrogen demand of a fruit tree, so as to enable the accurate application of a nitrogen fertilizer to the fruit tree.

Based on the same idea, the present disclosure also provides an apparatus for monitoring a nitrogen demand of a fruit tree.

The apparatus for monitoring a nitrogen demand of a fruit tree provided in the present disclosure is described below. The apparatus for monitoring a nitrogen demand of a fruit tree described below and the method for monitoring a nitrogen demand of a fruit tree described above can refer to each other.

FIG. 5 is a schematic diagram of a structure of the apparatus for monitoring a nitrogen demand of a fruit tree provided in the present disclosure.

In an exemplary embodiment of the present disclosure, as shown in FIG. 5, the apparatus for monitoring a nitrogen demand of a fruit tree can include an acquisition module 510, a construction module 520, and a processing module 530. Each module is described separately below:

The acquisition module 510 can be configured to acquire plant input parameters of the fruit tree to be monitored. The plant input parameters at least include a phenological development accumulated temperature parameter, a green leaf parameter, a photosynthesis parameter, a respiration parameter, a dry matter accumulation parameter, a partitioning parameter, and a nitrogen transport parameter.

The construction module 520 can be configured to construct a target monitoring model. The target monitoring model is a WOFOST model integrating nitrogen monitoring.

The processing module 530 can be configured to input the plant input parameters of the fruit tree to be monitored into the target monitoring model to obtain the nitrogen demand of the fruit tree to be monitored that is output by the target monitoring model.

In an exemplary embodiment of the present disclosure, the construction module 520 can construct the target monitoring model by the following process:

An initial WOFOST model is acquired.

Based on a first nitrogen content produced from mineralization and/or biological nitrogen fixation, a nitrogen use efficiency of the fruit tree, and a nitrogen absorption rate of the fruit tree, a soil nitrogen balance function is constructed.

Based on an actual nitrogen content of the fruit tree, a critical nitrogen content of the fruit tree, and a residual nitrogen content of the fruit tree, a nitrogen balance function between soil and the fruit tree is constructed.

A leaf growth rate function of the fruit tree under nitrogen stress and a biomass change function of the fruit tree under nitrogen stress are acquired.

Based on the soil nitrogen balance function, the nitrogen balance function between the soil and the fruit tree, the leaf growth rate function, and the biomass change function, the initial WOFOST model is improved to obtain the target monitoring model.

In an exemplary embodiment of the present disclosure, the construction module 520 can construct the leaf growth rate function by the following process:

A leaf nitrogen nutrient index of the fruit tree is acquired.

Based on the leaf nitrogen nutrient index, the leaf growth rate function is constructed.

In an exemplary embodiment of the present disclosure, the construction module 520 can construct the biomass change function of the fruit tree under nitrogen stress by the following process:

A radiation quantity of the fruit tree, a canopy nitrogen distribution coefficient of the fruit tree, and a light energy use efficiency of the fruit tree are acquired.

Based on the radiation quantity of the fruit tree, the canopy nitrogen distribution coefficient of the fruit tree, and the light energy use efficiency of the fruit tree, the biomass change function of the fruit tree under nitrogen stress is constructed.

In an exemplary embodiment of the present disclosure, the construction module 520 can be further configured to:

Acquire a development rate, a light duration correction coefficient, an average daily temperature, and a minimum development temperature of the fruit tree.

Based on the development rate, the light duration correction coefficient, the average daily temperature, and the minimum development temperature of the fruit tree construct a development value function of the fruit tree.

Optimize the target monitoring model based on the development value function to obtain an optimized target monitoring model, and take the optimized target monitoring model as a final target monitoring model.

In an exemplary embodiment of the present disclosure, the construction module 520 can be further configured to:

Based on a growth rate of leaf net dry matters of the fruit tree, construct a growth rate function of a leaf area index.

Based on a dry matter weight gain per unit time of the fruit tree, construct a dry matter weight generation function.

Optimize the target monitoring model based on the growth rate function of the leaf area index and the dry matter weight generation function to obtain an optimized target monitoring model, and take the optimized target monitoring model as a final target monitoring model.

In an exemplary embodiment of the present disclosure, the construction module 520 can be further configured to:

Acquire sample plant input parameters of a correction fruit tree sample.

Correct the target monitoring model based on the sample plant input parameters to obtain a corrected target monitoring model, and take the corrected target monitoring model as a final target monitoring model.

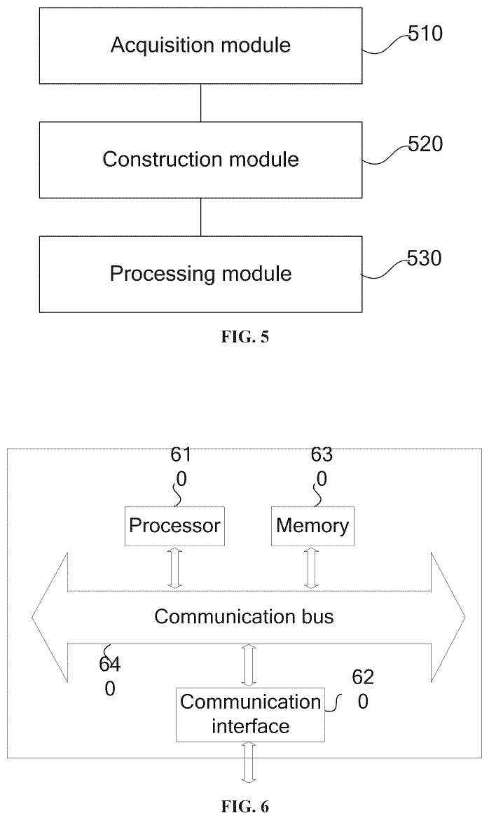

FIG. 6 is a schematic diagram of a physical structure of an electronic device. As shown in FIG. 6, the electronic device can include a processor 610, a communication interface 620, a memory 630, and a communication bus 640. The processor 610, the communication interface 620, and the memory 630 communicate with each other through the communication bus 640. The processor 610 can invoke a logical instruction in the memory 630 to implement the method for monitoring a nitrogen demand of a fruit tree. The method includes: Plant input parameters of the fruit tree to be monitored are acquired. The plant input parameters at least include a phenological development accumulated temperature parameter, a green leaf parameter, a photosynthesis parameter, a respiration parameter, a dry matter accumulation parameter, a partitioning parameter, and a nitrogen transport parameter. A target monitoring model is constructed. The target monitoring model is a WOFOST model integrating nitrogen monitoring. The plant input parameters of the fruit tree to be monitored are input into the target monitoring model to obtain the nitrogen demand of the fruit tree to be monitored that is output by the target monitoring model.

In addition, the logical instruction in the memory 630 can be implemented as a software function unit and can be stored in a computer-readable storage medium when sold or used as a separate product. Based on such understanding, the technical solutions of the present disclosure which are essential or a part contributing to the prior art or a part of the technical solutions may be embodied in the form of a software product, the computer software product is stored in a storage medium and includes a plurality of instructions for causing a computer device (which may be a personal computer, a server, or a network device) to implement all or some steps of the method according to each embodiment of the present disclosure. The storage medium includes a USB flash disk, a mobile hard disk, a read-only memory (ROM), a random access memory (RAM), a magnetic disk, an optical disk, or other media that can store program code.

The present disclosure also provides a computer program product. The computer program product includes a computer program, and the computer program can be stored in a non-transitory computer-readable storage medium. When executed by a processor, the computer program can implement the method for monitoring a nitrogen demand of a fruit tree described above. The method includes: Plant input parameters of the fruit tree to be monitored are acquired. The plant input parameters at least include a phenological development accumulated temperature parameter, a green leaf parameter, a photosynthesis parameter, a respiration parameter, a dry matter accumulation parameter, a partitioning parameter, and a nitrogen transport parameter. A target monitoring model is constructed. The target monitoring model is a WOFOST model integrating nitrogen monitoring. The plant input parameters of the fruit tree to be monitored are input into the target monitoring model to obtain the nitrogen demand of the fruit tree to be monitored that is output by the target monitoring model.

The present disclosure also provides a non-transitory computer-readable storage medium in which a computer program is stored. When executed by a processor, the computer program can implement the method for monitoring a nitrogen demand of a fruit tree described above. The method includes: Plant input parameters of the fruit tree to be monitored are acquired. The plant input parameters at least include a phenological development accumulated temperature parameter, a green leaf parameter, a photosynthesis parameter, a respiration parameter, a dry matter accumulation parameter, a partitioning parameter, and a nitrogen transport parameter. A target monitoring model is constructed. The target monitoring model is a WOFOST model integrating nitrogen monitoring. The plant input parameters of the fruit tree to be monitored are input into the target monitoring model to obtain the nitrogen demand of the fruit tree to be monitored that is output by the target monitoring model.

The apparatus embodiments described above are merely schematic, where the unit described as a separate component may or may not be physically separated, and a component displayed as a unit may or may not be a physical unit, that is, the component may be located at one place, or distributed on a plurality of network units. Some or all of the modules may be selected based on actual needs to allow the objectives of the solutions of the embodiments. Those of ordinary skill in the art can understand and implement the embodiments without creative efforts.

Through the description of the above implementations, those skilled in the art can clearly understand that the implementations can be implemented by means of software plus a necessary universal hardware platform, or certainly, can be implemented by hardware. Based on such understanding, the technical solutions essentially or the part contributing to the prior art may be implemented in a form of a software product. The computer software product may be stored in a computer-readable storage medium such as a ROM/RAM, a magnetic disk, or an optical disk, and includes several instructions for enabling a computer device (which may be a personal computer, a server, a network device, or the like) to execute the method according to each of the embodiments or parts of the embodiments.

Further, in the embodiments of the present disclosure, although operations are described in a particular order in the accompanying drawings, it should not be construed as requiring the implementation of the operations in the specific order or in a serial order or requiring the implementation of all of the operations to allow a desired result. In a given environment, multitasking and parallel processing may be advantageous.

Finally, it should be noted that the above embodiments are merely used to explain rather than limit the technical solutions of the present disclosure. Although the present disclosure is described in detail with reference to the above embodiments, those of ordinary skill in the art should understand that they can still modify the technical solutions described in the above embodiments, or make equivalent substitutions to some technical features therein, and these modifications or substitutions do not make the essence of the corresponding technical solutions depart from the spirit and scope of the technical solutions of the embodiments of the present disclosure.

The invention claimed is:

1. A method for monitoring a nitrogen demand of a fruit tree, comprising:
acquiring plant input parameters of a fruit tree to be monitored, wherein the plant input parameters comprise at least one selected from the group consisting of a phenological development accumulated temperature parameter, a green leaf parameter, a photosynthesis parameter, a respiration parameter, a dry matter accumulation parameter, a partitioning parameter, and a nitrogen transport parameter;
constructing a target monitoring model, wherein the target monitoring model is a WOrld FOod Studies (WOFOST) model integrating nitrogen monitoring; and
inputting the plant input parameters of the fruit tree to be monitored into the target monitoring model to obtain a nitrogen demand of the fruit tree to be monitored that is output by the target monitoring model.

2. The method for monitoring a nitrogen demand of a fruit tree according to claim 1, wherein the target monitoring model is constructed by:
acquiring an initial WOFOST model;
based on a first nitrogen content produced from mineralization and/or biological nitrogen fixation, a nitrogen use efficiency of the fruit tree, and a nitrogen absorption rate of the fruit tree, constructing a soil nitrogen balance function;
based on an actual nitrogen content of the fruit tree, a critical nitrogen content of the fruit tree, and a residual nitrogen content of the fruit tree, constructing a nitrogen balance function between soil and the fruit tree;
acquiring a leaf growth rate function of the fruit tree under nitrogen stress and a biomass change function of the fruit tree under nitrogen stress; and
based on the soil nitrogen balance function, the nitrogen balance function between the soil and the fruit tree, the leaf growth rate function, and the biomass change function, improving the initial WOFOST model to obtain the target monitoring model.

3. The method for monitoring a nitrogen demand of a fruit tree according to claim 2, wherein the leaf growth rate function is constructed by:
acquiring a leaf nitrogen nutrient index of the fruit tree; and
based on the leaf nitrogen nutrient index, constructing the leaf growth rate function.

4. The method for monitoring a nitrogen demand of a fruit tree according to claim 2, wherein the biomass change function of the fruit tree under nitrogen stress is constructed by:
acquiring a radiation quantity of the fruit tree, a canopy nitrogen distribution coefficient of the fruit tree, and a light energy use efficiency of the fruit tree; and
based on the radiation quantity of the fruit tree, the canopy nitrogen distribution coefficient of the fruit tree, and the light energy use efficiency of the fruit tree, constructing the biomass change function of the fruit tree under nitrogen stress.

5. The method for monitoring a nitrogen demand of a fruit tree according to claim 2, wherein after the initial WOFOST model is improved based on the soil nitrogen balance function, the nitrogen balance function between the soil and the fruit tree, the leaf growth rate function, and the biomass change function to obtain the target monitoring model, the method further comprises:
acquiring a development rate, a light duration correction coefficient, an average daily temperature, and a minimum development temperature of the fruit tree;
based on the development rate, the light duration correction coefficient, the average daily temperature, and the minimum development temperature of the fruit tree, constructing a development value function of the fruit tree; and
optimizing the target monitoring model based on the development value function to obtain an optimized target monitoring model, and taking the optimized target monitoring model as a final target monitoring model.

6. The method for monitoring a nitrogen demand of a fruit tree according to claim 2, wherein after the initial WOFOST model is improved based on the soil nitrogen balance function, the nitrogen balance function between the soil and the fruit tree, the leaf growth rate function, and the biomass change function to obtain the target monitoring model, the method further comprises:
based on a growth rate of leaf net dry matters of the fruit tree, constructing a growth rate function of a leaf area index;
based on a dry matter weight gain per unit time of the fruit tree, constructing a dry matter weight generation function; and
optimizing the target monitoring model based on the growth rate function of the leaf area index and the dry matter weight generation function to obtain an optimized target monitoring model, and taking the optimized target monitoring model as a final target monitoring model.

7. The method for monitoring a nitrogen demand of a fruit tree according to claim 2, wherein after the initial WOFOST model is improved based on the soil nitrogen balance function, the nitrogen balance function between the soil and the fruit tree, the leaf growth rate function, and the biomass change function to obtain the target monitoring model, the method further comprises:
acquiring sample plant input parameters of a correction fruit tree sample; and
correcting the target monitoring model based on the sample plant input parameters to obtain a corrected target monitoring model, and taking the corrected target monitoring model as a final target monitoring model.

8. An apparatus for monitoring a nitrogen demand of a fruit tree, comprising:
an acquisition module configured to acquire plant input parameters of a fruit tree to be monitored, wherein the plant input parameters comprise at least one selected from the group consisting of a phenological development accumulated temperature parameter, a green leaf parameter, a photosynthesis parameter, a respiration parameter, a dry matter accumulation parameter, a partitioning parameter, and a nitrogen transport parameter;
a construction module configured to construct a target monitoring model, wherein the target monitoring model is a WOFOST model integrating nitrogen monitoring; and
a processing module configured to input the plant input parameters of the fruit tree to be monitored into the target monitoring model to obtain a nitrogen demand of the fruit tree to be monitored that is output by the target monitoring model.

9. An electronic device, comprising a memory, a processor, and a computer program that is stored in the memory and able to run on the processor, wherein when executing the computer program, the processor implements the method for monitoring a nitrogen demand of a fruit tree according to claim 1.

10. A non-transitory computer-readable storage medium in which a computer program is stored, wherein when executed by a processor, the computer program implements the method for monitoring a nitrogen demand of a fruit tree according to claim 1.

11. The method for monitoring a nitrogen demand of a fruit tree according to claim 3, wherein after the initial WOFOST model is improved based on the soil nitrogen balance function, the nitrogen balance function between the soil and the fruit tree, the leaf growth rate function, and the biomass change function to obtain the target monitoring model, the method further comprises:
acquiring a development rate, a light duration correction coefficient, an average daily temperature, and a minimum development temperature of the fruit tree;
based on the development rate, the light duration correction coefficient, the average daily temperature, and the minimum development temperature of the fruit tree, constructing a development value function of the fruit tree; and
optimizing the target monitoring model based on the development value function to obtain an optimized target monitoring model, and taking the optimized target monitoring model as a final target monitoring model.

12. The method for monitoring a nitrogen demand of a fruit tree according to claim 4, wherein after the initial WOFOST model is improved based on the soil nitrogen balance function, the nitrogen balance function between the soil and the fruit tree, the leaf growth rate function, and the biomass change function to obtain the target monitoring model, the method further comprises:
acquiring a development rate, a light duration correction coefficient, an average daily temperature, and a minimum development temperature of the fruit tree;
based on the development rate, the light duration correction coefficient, the average daily temperature, and the minimum development temperature of the fruit tree, constructing a development value function of the fruit tree; and
optimizing the target monitoring model based on the development value function to obtain an optimized target monitoring model, and taking the optimized target monitoring model as a final target monitoring model.

13. The method for monitoring a nitrogen demand of a fruit tree according to claim 3, wherein after the initial WOFOST model is improved based on the soil nitrogen balance function, the nitrogen balance function between the soil and the fruit tree, the leaf growth rate function, and the biomass change function to obtain the target monitoring model, the method further comprises:
based on a growth rate of leaf net dry matters of the fruit tree, constructing a growth rate function of a leaf area index;
based on a dry matter weight gain per unit time of the fruit tree, constructing a dry matter weight generation function; and
optimizing the target monitoring model based on the growth rate function of the leaf area index and the dry matter weight generation function to obtain an optimized target monitoring model, and taking the optimized target monitoring model as a final target monitoring model.

14. The method for monitoring a nitrogen demand of a fruit tree according to claim 4, wherein after the initial WOFOST model is improved based on the soil nitrogen balance function, the nitrogen balance function between the soil and the fruit tree, the leaf growth rate function, and the biomass change function to obtain the target monitoring model, the method further comprises:
based on a growth rate of leaf net dry matters of the fruit tree, constructing a growth rate function of a leaf area index;
based on a dry matter weight gain per unit time of the fruit tree, constructing a dry matter weight generation function; and
optimizing the target monitoring model based on the growth rate function of the leaf area index and the dry matter weight generation function to obtain an optimized target monitoring model, and taking the optimized target monitoring model as a final target monitoring model.

15. The method for monitoring a nitrogen demand of a fruit tree according to claim 3, wherein after the initial WOFOST model is improved based on the soil nitrogen balance function, the nitrogen balance function between the soil and the fruit tree, the leaf growth rate function, and the biomass change function to obtain the target monitoring model, the method further comprises:
acquiring sample plant input parameters of a correction fruit tree sample; and
correcting the target monitoring model based on the sample plant input parameters to obtain a corrected target monitoring model, and taking the corrected target monitoring model as a final target monitoring model.

16. The method for monitoring a nitrogen demand of a fruit tree according to claim 4, wherein after the initial WOFOST model is improved based on the soil nitrogen balance function, the nitrogen balance function between the soil and the fruit tree, the leaf growth rate function, and the biomass change function to obtain the target monitoring model, the method further comprises:
acquiring sample plant input parameters of a correction fruit tree sample; and
correcting the target monitoring model based on the sample plant input parameters to obtain a corrected target monitoring model, and taking the corrected target monitoring model as a final target monitoring model.

17. The electronic device according to claim 9, wherein the target monitoring model is constructed by the following process:
acquiring an initial WOFOST model;
based on a first nitrogen content produced from mineralization and/or biological nitrogen fixation, a nitrogen use efficiency of the fruit tree, and a nitrogen absorption rate of the fruit tree, constructing a soil nitrogen balance function;
based on an actual nitrogen content of the fruit tree, a critical nitrogen content of the fruit tree, and a residual nitrogen content of the fruit tree, constructing a nitrogen balance function between soil and the fruit tree;
acquiring a leaf growth rate function of the fruit tree under nitrogen stress and a biomass change function of the fruit tree under nitrogen stress; and
based on the soil nitrogen balance function, the nitrogen balance function between the soil and the fruit tree, the leaf growth rate function, and the biomass change function, improving the initial WOFOST model to obtain the target monitoring model.

18. The electronic device according to claim 17, wherein the leaf growth rate function is constructed by the following process:
acquiring a leaf nitrogen nutrient index of the fruit tree; and
based on the leaf nitrogen nutrient index, constructing the leaf growth rate function.

19. The electronic device according to claim 17, wherein the biomass change function of the fruit tree under nitrogen stress is constructed by the following process:
acquiring a radiation quantity of the fruit tree, a canopy nitrogen distribution coefficient of the fruit tree, and a light energy use efficiency of the fruit tree; and
based on the radiation quantity of the fruit tree, the canopy nitrogen distribution coefficient of the fruit tree, and the light energy use efficiency of the fruit tree, constructing the biomass change function of the fruit tree under nitrogen stress.

20. The electronic device according to claim 17, wherein after the initial WOFOST model is improved based on the soil nitrogen balance function, the nitrogen balance function between the soil and the fruit tree, the leaf growth rate function, and the biomass change function to obtain the target monitoring model, the method further comprises:
acquiring a development rate, a light duration correction coefficient, an average daily temperature, and a minimum development temperature of the fruit tree;
based on the development rate, the light duration correction coefficient, the average daily temperature, and the minimum development temperature of the fruit tree, constructing a development value function of the fruit tree; and
optimizing the target monitoring model based on the development value function to obtain an optimized target monitoring model, and taking the optimized target monitoring model as a final target monitoring model.
